(19) United States
(12) Patent Application Publication
(10) Pub. No.: US 2015/0015706 A1
(43) Pub. Date: Jan. 15, 2015

(54) VEHICLE EXTERIOR IMAGE CAPTURING DEVICE

(71) Applicants: HONDA MOTOR CO., LTD., (US); HONDA ACCESS CORP., NIIZA-SHI (JP)

(72) Inventors: Hiroyuki Hatori, Niiza-shi (JP); Fumihiko Aizawa, Niiza-shi (JP); Tomohisa Kato, Niiza-shi (JP); Tokio Isono, Wako-shi (JP); Yasuyo Mitsumori, Wako-shi (JP)

(73) Assignees: HONDA MOTOR CO., LTD., TOKYO (JP); HONDA ACCESS CORP., NIIZA-SHI (JP)

(21) Appl. No.: 13/937,617

(22) Filed: Jul. 9, 2013

(51) Int. Cl. H04N 7/18; G06K 9/00

(52) U.S. Cl. CPC H04N 7/18; G06K 9/00832; G06K 9/00771
USPC 348/148

(57) ABSTRACT

A vehicle exterior image capturing device is provided with a detecting unit, such as a sensor microphone and a sensor camera, that detects a predetermined change n conditions of an occupant in a compartment of a vehicle, an exterior image capturing unit that continuously images the exterior of the vehicle compartment and generates a series of exterior images, and a storage unit that stores a part of the series of exterior images when the predetermined occupant's condition change is detected by the detecting unit. The vehicle exterior image capturing device may further include an interior image capturing unit that continuously images the interior of the vehicle compartment and generates a series of interior images. In the latter case, the storage unit also stores a part of the series of interior images.

### TECHNICAL FIELD

The present invention relates to a vehicle exterior image capturing device configured to detect a predetermined change in conditions of an occupant in a vehicle compartment and store a captured image exterior of the vehicle.

### BACKGROUND ART

Image capturing devices are disclosed, for example, in Japanese Patent Application Laid-open Publication (JP-A) No. 2009-49950. The disclosed image capturing device is disposed on a dashboard and configured to capture images exterior of a vehicle compartment in a traveling direction (forward direction) of the vehicle and to store the captured images. The image capturing device determines a capturing time interval according to the speed of the vehicle on which the image capturing device is installed. By thus determining the image capturing timing according to the vehicle speed, the image capturing device is able to capture an image at each fixed distant space and store the captured image.

However, in the foregoing image capturing device, there is a possibility that the image stored at each fixed distant space does not represent a moment which is optimal to the user. Accordingly, in order to store an image at an optimal moment, it is necessary to continue image storing at all times. In other words, storing an image at an optimal moment will require an increased storage capacity.

### SUMMARY OF THE INVENTION

It is, therefore, an object of the present invention to provide a vehicle exterior image capturing device which is capable of suppressing an increase in the storage capacity.

According to the present invention, there is provided a vehicle exterior image capturing device, comprising: a detecting unit that detects a predetermined change in conditions of an occupant in a compartment of a vehicle; an exterior image capturing unit that continuously images the exterior of the compartment and generates a series of exterior images; and a storage unit that stores a part of the series of exterior images when the predetermined condition change is detected by the detecting unit.

With this arrangement, the series of exterior images generated by the exterior image capturing unit can contain an image at an optimal moment. In other words, discontinuously captured images (for example, those captured at given intervals of distance) possibly fail to represent an optimal moment. The vehicle exterior image capturing device of the invention is equipped with an exterior image capturing unit that generates a series of exterior images including an image at an optimal moment. The device does store in its storage unit not all of, but only a part of, the series of exterior images. Thus, an increase in the storage capacity of the storage unit can be suppressed. To make sure that part of the series of external images represents an optimal moment, the vehicle exterior image capturing device is equipped with a detecting unit that detects a predetermined change in conditions of an occupant in the vehicle compartment (such as an event that the occupant gives a cheer, or an event that the occupant looks at scenery outside the vehicle compartment).

Preferably, the vehicle exterior image capturing device further comprises an interior image capturing unit that continuously images the interior of the compartment, and generates a series of interior images, wherein when the predetermined condition change is detected by the detecting unit, the storage unit also stores a part of the series of interior images.

Thus, the storage unit is able to store not only an exterior image (such as scenery) at an optimal moment, but also an interior image (such as a situation in the vehicle compartment) at an optimal moment.

The interior image capturing unit may be installed on a ceiling of the compartment in such a manner as to be movable in both a forward direction and a rearward direction of the compartment. By thus moving in the forward and rearward direction of the vehicle compartment, the interior image capturing unit makes it possible to store interior images with increased accuracy. Such interior image capturing unit is particularly effective when used in a vehicle, such as a minivan or a bus, having a compartment elongated in a front-back direction of the vehicle.

The detecting unit may be a detection image capturing unit that images the compartment from a front to a rear of the compartment and generates a detection image, wherein the detection image capturing unit detects the predetermined condition change by detecting a predetermined change of pixels in an area of the detection image where a driver and windows of the vehicle have been removed.

Generally, the movement of the vehicle driver occurs with driving, and the scenery over the window changes with the movement of the vehicle. In view of this, an area in which a comparatively large pixel change takes place is removed from the detection image. With this arrangement, even when the detection image capturing unit is used for the detection of the predetermined condition change, an image not anticipated by the user such as the driver is kept from being stored in the storage unit.

The detecting unit may be a detection sound recording unit that records sounds in the compartment and generates a detection sound, wherein the detection sound recording unit detects the predetermined condition change by detecting a predetermined change in sound volume when the detection sound has a volume value equal to or greater than a predetermined value.

In general, with the movement of the vehicle, traveling sound can be transmitted to the inside of the vehicle compartment. In view of this, a sound not to express an essential interior sound is removed or eliminated from the detection sound. With this arrangement, even when the detection sound recording unit is used for the detection of the predetermined condition change, an image not anticipated by the user such as the driver is kept from being stored in the storage unit.

### BRIEF DESCRIPTION OF THE DRAWINGS

One preferred structural embodiment of the present invention will be described in detail herein below, by way of example only, with reference to the accompanying sheets of drawings, in which:

FIG. 1 is a block diagram showing a general configuration of a vehicle exterior image capturing device according to an embodiment. of the present invention;

FIG. 2 is a diagrammatical view an arrangement of the vehicle exterior image capturing device;

FIGS. 3A to 3D are appearance diagrams, respectively, showing a sensor microphone, a sensor camera, a vehicle exterior camera, and a vehicle interior camera shown in FIG. 2;

FIG. 4A is a graph showing a temporal change of the sound pressure generated by the sensor microphone shown in FIG. 1;

FIG. 4B is a graph showing vehicle speed dependencies of a predetermined value shown in FIG. 4A;

FIG. 5 is a view showing an example of images generated by the sensor camera shown in FIG. 2;

FIG. 6 is a diagram showing a constitutional example of video images stored by a storage means shown in FIG. 1;

FIG. 7A is a view showing the appearance of a display unit shown in FIG. 1;

FIG. 7B is a view showing an indication example of icons in a display region of the display unit;

FIGS. 8A and 8B are views showing reproduction examples of a moving picture stored in the storage means shown in FIG. 1; and

FIGS. 9A to 9C are views showing reproduction examples of a moving picture (interior images) stored in the storage means shown in FIG. 1.

### DETAILED DESCRIPTION OF THE PREFERRED EMBODIMENT

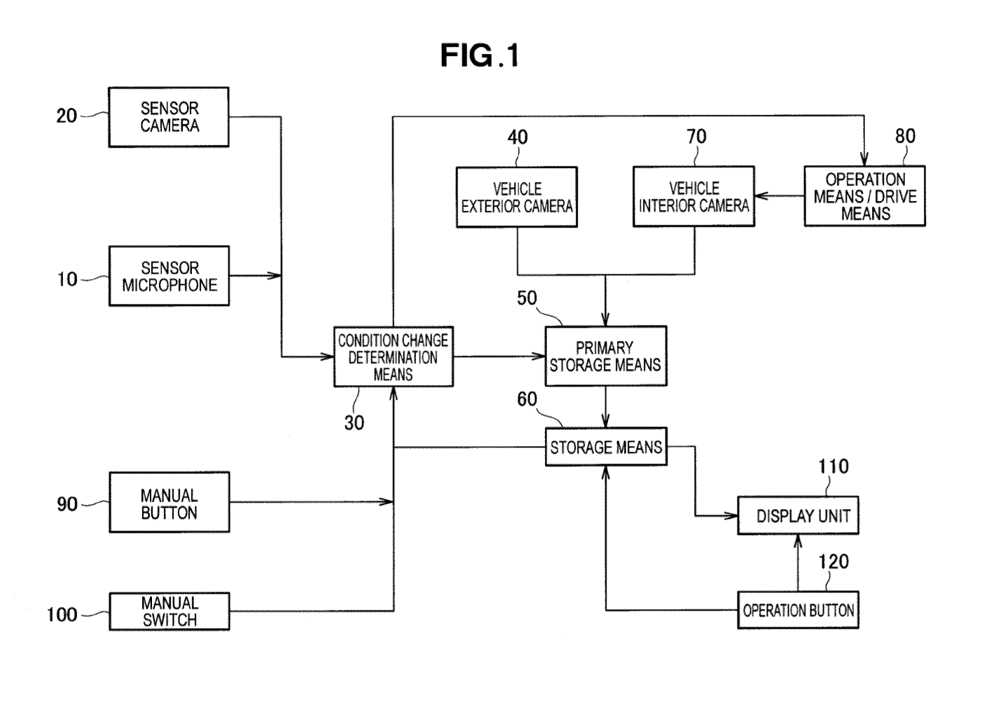

As shown in FIG. 1, a vehicle exterior image capturing device of the present invention generally comprises a detecting unit such as a sensor microphone 10, an exterior image capturing unit such as a vehicle exterior camera 40, and a storage unit such as a storage means 60. The detecting unit detects a predetermined change in conditions of an occupant (a user of the vehicle exterior image capturing device) in a compartment 130 of a vehicle such as an automobile. The sensor microphone 10 and/or a sensor camera 20 may constitute the detecting unit. The exterior image capturing unit continuously images the exterior of the compartment. 130 and generates a series of exterior images. The series of exterior images are stored in a primary storage means 50. When the predetermined condition change of the occupant in the compartment 130 is detected, the storage means 60 stores a part of the series of exterior images. The primary storage means 50 may he formed by an internal memory of the vehicle exterior camera 40 or a flash memory drive, for example. The storage means 60 may be formed by a hard disk drive.

The vehicle exterior camera 40 continuously images the exterior of the compartment 130 and is, therefore, different from the image capturing device shown in FIG. 3 of JP 2009-49950A, wherein an image is captured at each fixed distant space Lx. Since the vehicle exterior camera 40 continuously images the exterior of the compartment 130 and generates a series of exterior images, thus generated series of exterior images can contain an image at an optimal moment. By contrast, discontinuously captured images (such as those images which are captured at fixed intervals of distance) possibly fail to express an optimal moment.

In the case where successive exterior images are continuously stored, this will cause an increase in the storage capacity. To avoid this problem from occurring, the primary storage means 50 stores only the latest series of exterior images of a certain fixed quantity, and exterior images that become old are sequentially replaced by new exterior images. In other words, the series of exterior images are only stored temporarily in the primary storage means 50. Thus, the primary storage means 50 can endlessly store a series of exterior images of a certain fixed quantity.

The storage means 60 is able to store a part of the series of exterior images in a certain timing. In other words, the storage means 60 does not always continue to store the series of exterior images, but it does store a part of the series of exterior images in a timing wherein an image at an optimal moment is included in the stored part of the exterior images. This will suppress an increase in storage capacity of the storage means 60. To ensure that the stored part of the exterior images expresses an optimal moment, the sensor microphone 10 detects an event that the occupant gives a cheer, for instance, and the sensor camera 20 detects an event, that the occupant looks at the exterior of the compartment 130.

In the embodiment shown in FIG. 1, the vehicle exterior image capturing device may further comprise an interior image capturing unit such as a vehicle interior camera 70. The interior image capturing unit continuously images the interior of the compartment 130 and generates a series of interior images. The primary storage means 50 is able to endlessly store, with a predetermined amount of storage capacity, both a series of exterior images and a series of interior images. When a predetermined change in conditions of the occupant in the compartment 130 is detected by the sensor microphone 10 for example, the storage means 60 stores both a part of the series of exterior images and a part of the series of interior images. Thus, the storage means 60 is able to store not only an exterior image (such as scenery) at an optimal moment, but also an interior image (such as a situation in the vehicle compartment) at an optimal moment.

In the embodiment shown in FIG. 1, the vehicle exterior image capturing device is equipped with the sensor microphone 10 and the sensor camera 20 and it further includes a condition change determination means 30. The sensor microphone 10, the sensor camera 20, and the condition change determination means 30 jointly form the detecting unit. A detection sound recording unit such as the sensor microphone 10 records sounds in the compartment 130 and generates a detection sound, and it also sends the generated detection sound to a processing unit such as the condition change determination means 30. A detection image capturing unit such as the sensor camera 20 images the interior of the compartment 130 and generates a detection image, and it also sends the generated detection image to the processing unit such as the condition change determination means 30. The processing unit such as the condition change determination means 30 may be comprised of a CPU (central processing unit), a MPU (micro processing unit), an ECU (electronic control unit) or the like. The condition change determination means 30 determines the existence of a predetermined occupant's condition change based on the detection sound and/or the detection image. When the predetermined occupant's condition change is present, the condition change determination means 30 sends a signal (trigger signal) indicative of the presence of the predetermined occupant's condition change to the primary storage means 50. On the basis of this signal, the primary storage means 50 sends a part of the series of exterior images and a part of the interior images to the storage means 60.

In the embodiment shown in FIG. 1, the vehicle exterior image capturing device may further comprise a manual button 90. The manual button 90 is able to detect operation by the occupant. When depressed by the occupant, the manual button 90 sends a trigger signal (indicative of an occupant's intention to store) to the condition change determination means 30. In this instance, the storage means 60 stores a part of the series of external images, for example, based on a trigger signal from the condition change determination means 30. The detecting unit such as the sensor microphone 10 is able to automatically detect a predetermined occupant's condition change and, hence, it is advantageous for a reduced burden on the occupant. On the other hand, the manual button 90 is advantageous in that an image at an optimal moment can be stored with increased reliability.

As shown in FIG. 1, the vehicle exterior image capturing device may further comprise a manual switch 100. The manual switch 100 can control the condition change determination means 30 such that the issuance of a trigger signal from the condition change determination means 30 to the primary storage means 50 is disabled. By virtue of the manual switch 100, a vehicle door opening and shutting sound, a vehicle engine starting sound, or an image not anticipated by the occupant is prevented from being stored in the storage means 60. In the embodiment shown in FIG. 1, the vehicle exterior image capturing device may further comprise a display unit 110, an operation button 120 and an operation means/drive means 80, as will be discussed later.

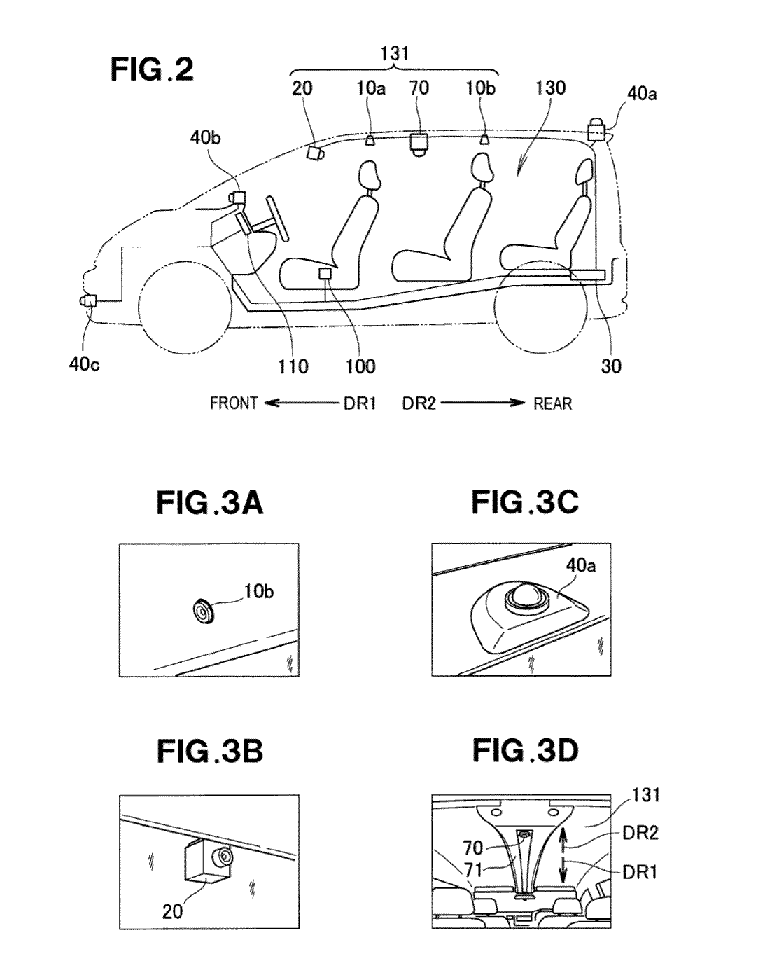

As shown in FIG. 2, the vehicle exterior camera 40 (exterior image capturing unit) shown in FIG. 1 comprises three vehicle exterior cameras 40a, 40b and 40c. The exterior image capturing unit may be constituted either by a single vehicle exterior camera or by a plurality of vehicle exterior cameras. In the embodiment shown in FIG. 2, the vehicle exterior camera 40a is disposed on a rear end portion of the vehicle roof. The vehicle exterior camera 40b is disposed on a dashboard, and the vehicle exterior camera 40c is disposed on a front bumper. Each of the three vehicle exterior cameras 40a, 40b, 40c is able to image the exterior of the compartment 130 and also to generate a series of exterior images.

In the embodiment shown in FIG. 2, the sensor microphone 10 (detecting unit) shown in FIG. 1 comprises two sensor microphones 10a and 10b. As shown in FIG. 2, the sensor microphone 10a is installed on a front part of a ceiling of the compartment 130, and the sensor microphone 10b is installed on a rear part of the ceiling of the compartment 130. Each of the sensor microphones 10a, 10b is able to continuously record sounds in the compartment. 130 and to generate a series of detection sounds. In the embodiment shown in FIG. 2, the sensor camera 20 and the vehicle interior camera 70 are installed on the ceiling. The sensor camera 20 (detecting unit) is able to continuously image the interior of the compartment 130 and to generate a series of detection images. The vehicle interior camera 70 (interior image capturing unit) is able to continuously image the interior of the compartment 130 and to generate a series of interior images.

In the embodiment shown in FIG. 2, the condition change determination means 30 shown in FIG. 1 is disposed on a rear part of the vehicle floor, the manual switch 100 shown in FIG. 1 is disposed on a first seat row, and the display unit 110 shown in FIG. 1 is disposed in the dashboard. Though not shown in FIG. 2, the manual button 90 and the operation means/drive means 80 both shown in FIG. 1 are disposed near the manual switch 100. Similarly, though not shown in FIG. 2, the operation button 120 shown in FIG. 1 may be composed of a touch panel display, which doubles in function as the display unit 110 and the operation button 120.

FIGS. 3A-3D are appearance views, respectively, showing the sensor microphone 10b, the sensor camera 20, the vehicle exterior camera 40a, and the vehicle interior camera 70 that are shown in FIG. 2. The sensor microphone 10b deals with the second and third seat rows and is able to detect a human voice around a rear part of the compartment 130 (FIGS. 2 and 3A). In the case where the sensor microphone 10b is disposed on a right side of a rear part of the ceiling, another sensor microphone, not shown, may be added and disposed on a left side of the rear part of the ceiling. In other words, the sensor microphone 10b disposed on the rear part of the ceiling may be composed of two microphones.

The sensor camera 20 is able to image the compartment 130 from a front to a rear thereof to thereby detect the movement of the occupant (FIGS. 2 and 3B). The vehicle exterior camera 40a is able to image scenery outside the compartment 130 and may be constituted by a 360-degree camera (omnidirectional camera) (FIGS. 2 and 3C). The vehicle interior camera 70 is installed on the ceiling 131 of the compartment 130 in such a manner as to be movable in both a forward direction DR1 and a rearward direction DR2 of the compartment 130 (FIGS. 2 and 3D). In the embodiment shown in FIG. 3D, the vehicle interior camera 70 is drivable by a motor, not shown, to undergo movement along a rail 71.

By thus moving the vehicle interior camera 70 (interior image capturing unit) in a front-back direction of the compartment 130, it is possible to store interior images in the storage means 60 with improved accuracy. Such vehicle interior camera 70 is particularly effective when used in a vehicle, such as a minivan or a bus, having a compartment elongated in the front-back direction of the vehicle. As shown in FIG. 2, the sensor microphone 10 is composed of two sensor microphones 10a and 10b so that both a cheer arising from a front part of the compartment 130 and a cheer arising from a rear part of the compartment 130 can he detected separately and independently. It is also possible to move the vehicle interior camera 70 in the front-hack direction of the compartment 130 so as to automatically approach a position where the cheer is arising.

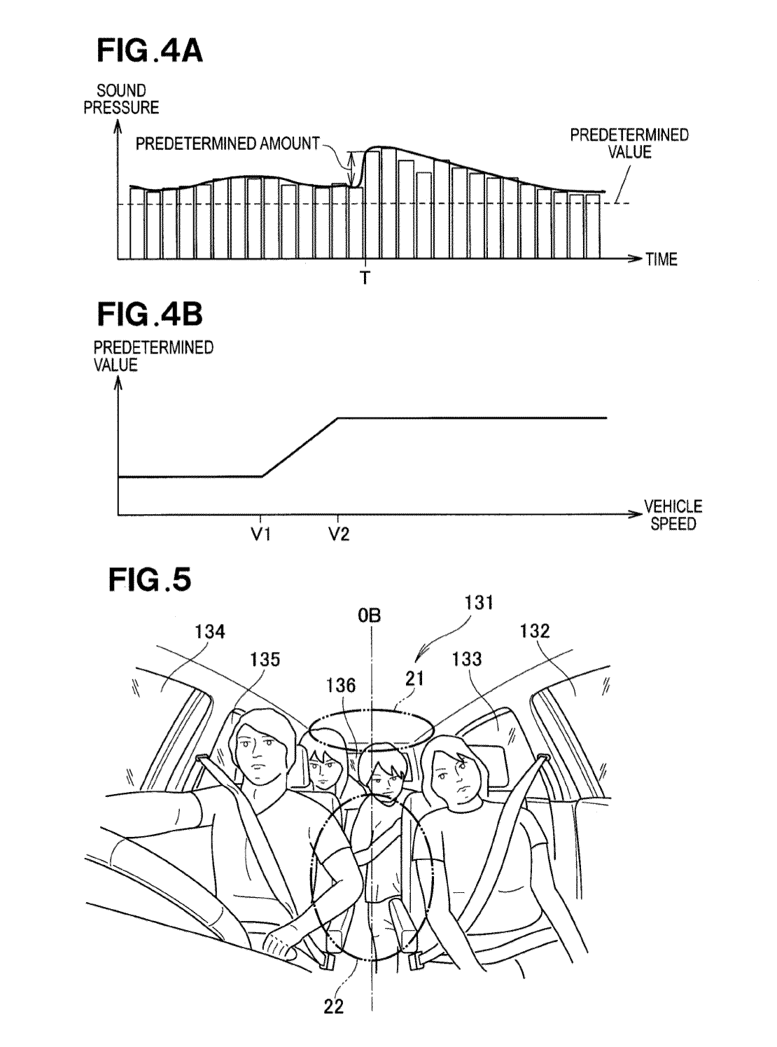

Referring next to FIG. 4A, the sound pressure can be obtained by adding-up two sound pressures obtained by the respective sensor microphones 10a, 10b. However, when a position where a cheer is arising is to be detected, it is preferable to use a sound pressure from each respective sensor microphone as the sound pressure shown in FIG. 4A. As exemplified in FIG. 4A, the sound pressure (indicated by a solid line) increases by a predetermined amount at a time T. The sound pressure (bar chart) shows detection sounds sampled at predetermined time interval. A predetermined change in sound pressure at time T, such as shown in FIG. 4A, (which represents a change of the difference between a sound pressure at the previous sampling time and a sound pressure at the latest sampling time that shows an increase by a predetermined amount) can be detected by the condition change determination means 30 (processing unit).

In general, with the movement of the vehicle, traveling sound can be transmitted to the inside of the compartment 130. It is preferable that a sound not to express an essential interior sound is removed or eliminated from the detection sound. In view of this, the condition change determination means 30 (processing unit, detection sound recording unit) is preferably configured to determine whether a predetermined change in sound volume is present among the detection sounds on condition that the detection sounds are not less than a predetermined value. More specifically, any sound pressure smaller than the predetermined value indicated by a dotted line shown in FIG. 4A is regarded as a road noise. By thus performing a detection of a predetermined change in sound value only when the detection sounds are not less than the predetermined value, the condition change determination means 30 is able to prevent an image not anticipated by the Occupant from being stored in the storage means 60. The condition change determination means 30 may apply filter processing to the detection sounds so that the sound pressure shown in FIG. 4A represents only the voice sound pressure of an occupant (preferably, a person recognized in advance) detected through a frequency filter.

As shown in FIG. 4B, the predetermined value can be changed with the vehicle speed. In general, the traveling sound (road noise) increases with the vehicle speed. Even when the vehicle speed is high, the traveling sound is saturated. Furthermore, a sound from the outside of the compartment 130 can occasionally come in the compartment 130 even when the vehicle speed is low or when the vehicle is stopped. In the embodiment shown in FIG. 4B, the predetermined value increases linearly as the vehicle speed increases from a value V1 to a value V2. The setting of the predetermined value should by no means be limited to the embodiment shown in FIG. 4B.

In the embodiment shown in FIG. 5, four occupants are present in the compartment 130. An image generated by the sensor camera 20 includes a driver of adult man (in a driver's seat in the first seat row), an adult woman (in a navigator's seat in the first, seat row), a boy (in the second seat row), and a girl (in the second seat row). The image generated by the sensor camera 20 also includes windows 132, 133, 134 and 135. In general, the movement of the vehicle driver occurs with driving, and the scenery over the windows 132, 133, 134, 135, 136 changes with the movement of the vehicle. It is, therefore, preferable that an area in which a comparatively large pixel change takes place is removed from the detection image. To this end, it is desirable for the sensor camera 20 to detect a predetermined change of pixels in an area of the detection image where the driver and the windows have been removed. As shown in FIG. 5, a vertical centerline OB of the compartment 130 passes through a point midway between the driver's seat and the navigator's seat. The area nearby the centerline OB (excluding a region including the rear window 136) is an area where a pixel change occurs relatively scarcely. In the embodiment shown in FIG. 5, detection areas 21 and 22 are set in the vicinity of the centerline OB. The detection area 21 is an area located at a rear part of the ceiling 131 (on an upper side of the rear window 136), and the detection area 22 is an area located between the driver's seat and the navigator's seat (on a lower side of the rear window 136). The detection area 21 ensures that the boy and the girl leaning forward in the second seat row can be detected. The detection area 22 ensures that an event where the adult man and woman in the first seat row join hands can be detected. It is preferable that the sensor camera 20 detects a predetermined change of pixels in an area (excluding a region including the rear window 136), such as the area, set in the vicinity of the centerline OB.

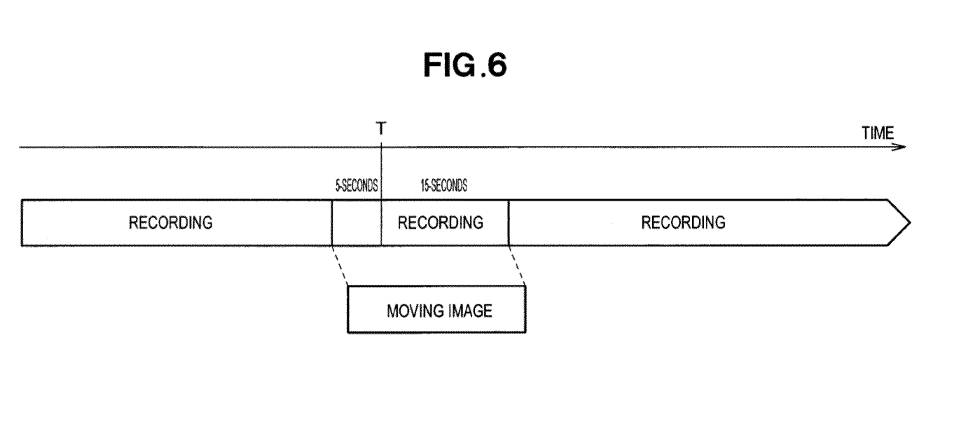

In the embodiment shown in FIG. 6, a time T corresponds to the time T shown in FIG. 4A and represents a time when a predetermined occupant's condition change is detected. As shown in FIG. 6, the primary storage means 50 shown in FIG. 1 is able to record a series of exterior images, and the storage means 60 shown in FIG. 1 is able to record only a part of the series of exterior images which corresponds to a time period starting at a first time five seconds before the time T and ending at a second time fifteen seconds after the time T. In the embodiment shown in FIG. 6, the image stored in the storage means 60 is a moving image continuing for twenty seconds. The storage time for the moving image is not limited to twenty seconds. Instead, the storage means 60 may store a moving image continuing for twenty seconds from the time T, or alternatively, it may store a still image when triggered at the time T.

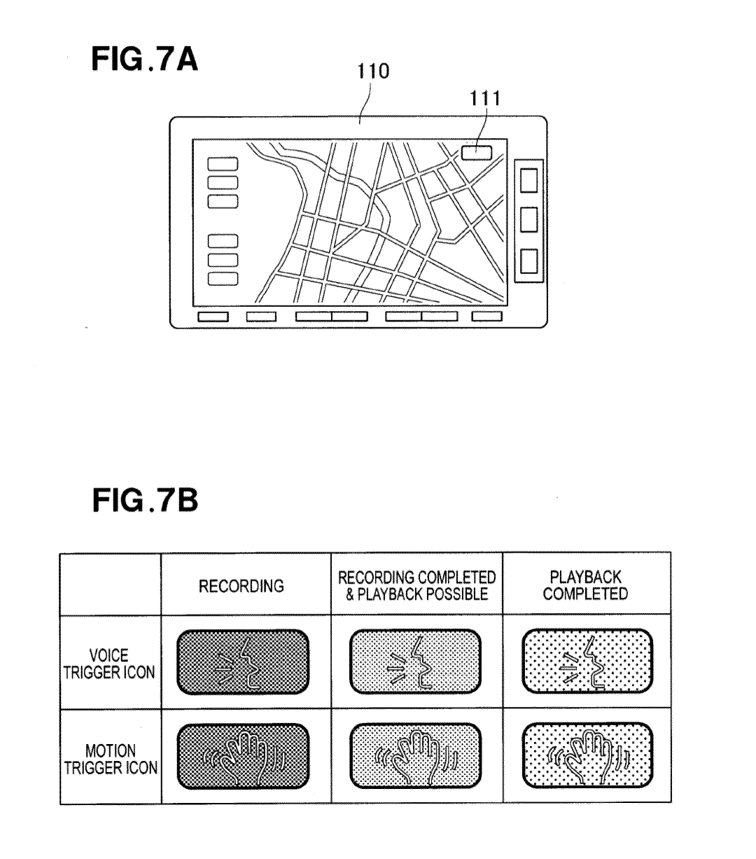

In the embodiment shown in FIG. 7A, the display unit 110 comprises a car navigation device. The car navigation device can display maps as well as an icon 111 to show an operating condition of the vehicle exterior image capturing device. As shown in FIG. 7B, the icon 111 is able to show “RECORDING”, “RECORDING COMPLETED & PLAYBACK POSSIBLE”, and “PLAYBACK COMPLETED” by distinguishing them from one another. For instance when the icon 111 displays “RECORDING”, it is colored red. The icon 111 is colored yellow when it displays “RECORDING COMPLETED & PLAYBACK POSSIBLE”. The icon 111 is colored green when displaying “PLAYBACK COMPLETED”.

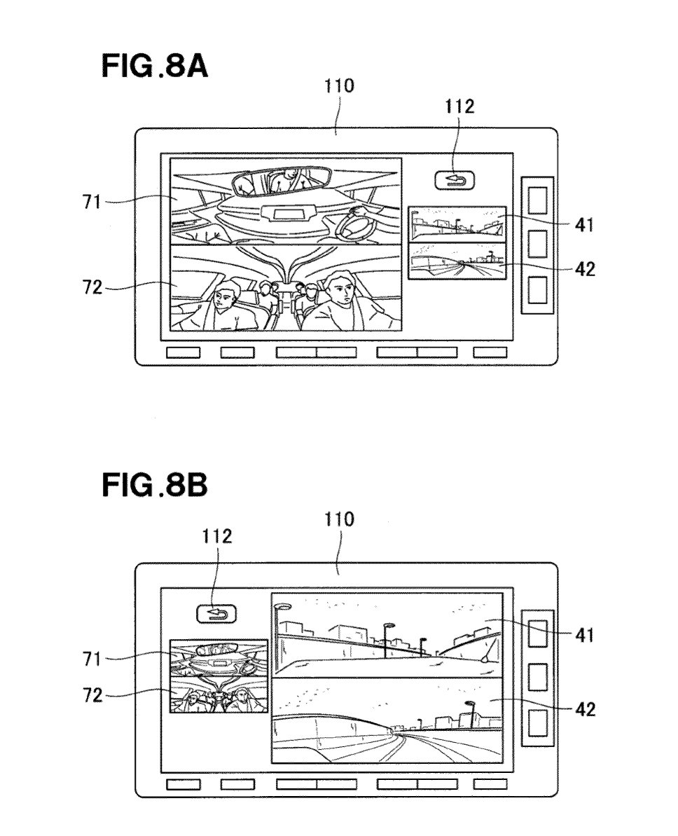

When a moving image continuing for twenty seconds is being recorded in the storage means 60, the icon showing “RECORDING” is displayed. When the recording of the moving image in the storage means 60 has completed and before the stored moving image is reproduced, the icon showing “RECORDING COMPLETED & PLAYBACK POSSIBLE” is displayed on the screen. When the reproduction of the moving image in the storage means 60 has completed and before the next moving image is recorded in the storage means 60, the icon showing “PLAYBACK COMPLETED” is displayed on the screen. The operation button 120 shown in FIG. 1 is able to control the display unit 110 and may be constituted by the icon 111 showing the “RECORDING COMPLETED & PLAYBACK POSSIBLE”. While the icon showing “RECORDING COMPLETED & PLAYBACK POSSIBLE” remains displayed on the screen, the occupant touches the icon 111 whereupon the car navigation device (display unit 110) switches from a navigation screen containing a map to a reproduction screen and is in a condition ready to display a moving image stored in the storage means 60 (see FIG. 8A, for example).

As shown in FIG. 7B, the icon 111 can also display “VOICE TRIGGER” and “MOTION TRIGGER” by distinguishing them from each other. The icon 111 representing “VOICE TRIGGER” is shown by an illustration expressing a mouth and implies that the time T (trigger) shown in FIG. 6 is generated by the sensor microphone 10. The icon representing “MOTION TRIGGER” is shown by an illustration expressing a hand and implies that the time T (trigger) shown in FIG. 6 is generated by the sensor camera 20.

The condition change determination means 30 may suspend its determination processing as long as the icon 111 indicating “RECORDING” or the icon indicating “RECORDING COMPLETED & PLAYBACK POSSIBLE” remains displayed after detection of a predetermined occupant's condition change at the time T (trigger). With this arrangement, because the issuance of a new trigger from the condition change determination means 30 is disabled, a useless reaction by the storage means 60 can be avoided. Furthermore, after the icon 111 indicating “PLAYBACK COMPLETED” is displayed, the condition change determination means 30 may suspend its determination processing for five seconds. Soon after having played a moving image in the storage means 60, a human voice (to express impressions after watching the moving image) is likely to occur. However, by thus suspending the determination processing in the condition change determination means 30, it is possible to preclude a useless reaction by the storage means 60.

In the embodiment shown in FIG. 8A, images displayed on a screen of the car navigation device (display unit 110) include interior images 71, 72 captured by the vehicle interior camera 70 (interior image capturing unit), and exterior images 41, 42 captured by the vehicle exterior camera 40a (exterior image capturing unit). The vehicle interior camera 70 may be constituted by a 360-degree camera (omnidirectional camera) in which instance the interior image 71 corresponds to an image taken with respect to an angular range of from 0 to 180 degrees, and the interior image 72 corresponds to an image taken with respect to an angular range of from 180 to 360 degrees. The display unit 110 is also able to display an icon representing a loop button 112. In the embodiment shown in FIG. 8B, images displayed on the screen of the display unit 110 include interior images 71, 72 (of the small screen) and exterior images 41, 42 (of the large screen).

The operation button 120 shown in FIG. 1 may be constituted by the exterior images 41, 42 (of the small screen) and the loop button 112 shown in FIG. 8A. In the embodiment shown in FIG. 8A, when the occupant touches the exterior images 41, 42 (of the small screen), the display unit 110 will enlarge the exterior images 41, 42 and reduce the interior images 71. 72 (see FIG. 8B). Furthermore, in the embodiment shown in FIG. 8A, when the occupant touches the loop button 112, the display unit 110 will undertake continuous reproduction of moving images recorded in the storage means 60.

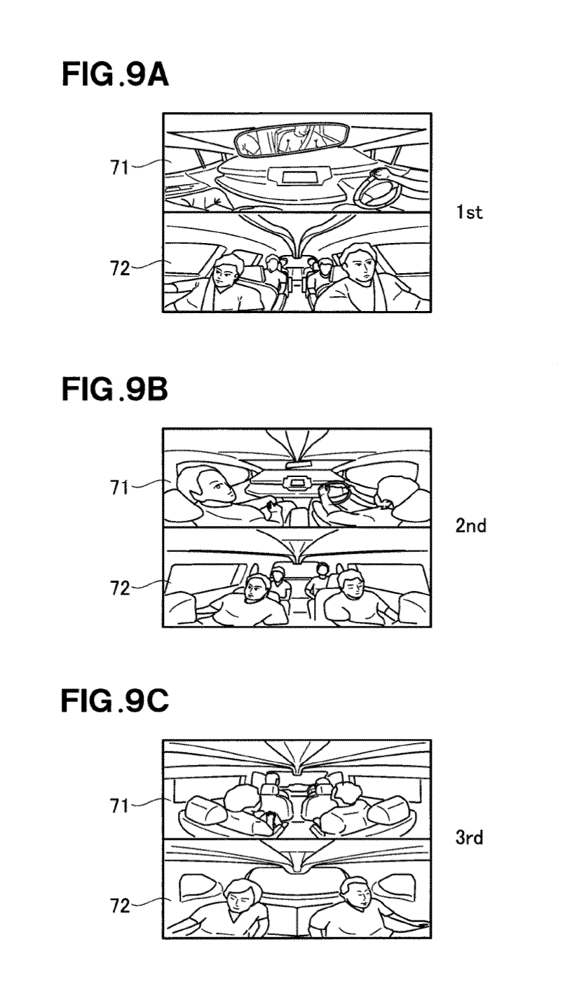

FIG. 9A exemplifies interior images 71, 72 captured when the vehicle interior camera 70 shown in FIG. 2 is disposed in a position where a special emphasis is placed on the first seat row. FIG. 9B exemplifies interior images 71, 72 captured when the vehicle interior camera 70 shown in FIG. 2 is disposed in a position, where a special emphasis is placed on the second seat row. FIG. 9C exemplifies interior images 71, 72 captured when the vehicle interior camera 70 is disposed in a position where a special emphasis is placed on the third seat row. As previously described, the vehicle interior camera 70 is automatically movable in the front-back direction of the compartment 130 in conjunction with the detection of a human voice by means of the sensor microphone 10. Accordingly, by displacing the vehicle interior camera 70 to a predetermined position set for each seat row, an occupant's facial expression in the compartment 130 can be stored with increased accuracy. Furthermore, the operation means/drive means 80 shown in FIG. 1 can operate to displace the position of the vehicle interior camera 70 in the front-back direction depending on each individual occupant. When an occupant operates the operation means 80, the drive means 80 sends a corresponding drive signal to a motor by means of which the vehicle interior camera 70 is drivable to undergo movement in the front-back direction.

Obviously, various minor changes and modifications of the present invention are possible in light of the above teaching. It is therefore to be understood that within the scope of the appended claims the invention may be practiced otherwise than as specifically described.

What is claimed is:

1. A vehicle exterior image capturing device, comprising:
a detecting unit that detects a predetermined change in conditions of an occupant in a compartment of a vehicle;
an exterior image capturing unit that continuously images the exterior of the compartment and generates a series of exterior images; and
a storage unit that stores a part of the series of exterior images when the predetermined condition change is detected by the detecting unit.

2. The vehicle exterior image capturing device according to claim 1, further comprising an interior image capturing unit that continuously images the interior of the compartment and generates a series of interior images, wherein when the predetermined condition change is detected by the detecting unit, the storage unit also stores a part of the series of interior images.

3. The vehicle exterior image capturing device according to claim 2, wherein the interior image capturing unit is installed on a ceiling of the compartment in such a manner as to be movable in both a forward direction and a rearward direction of the compartment.

4. The vehicle exterior image capturing device according to claim 1, wherein the detecting unit comprises a detection image capturing unit that images the compartment from a front to a rear thereof and generates a detection image, wherein the detection image capturing unit detects the predetermined condition change by detecting a predetermined change of pixels in an area of the detection image where a driver and windows of the vehicle have been removed.

5. The vehicle exterior image capturing device according to claim 1, wherein the detecting unit comprises a detection sound recording unit that records sounds in the compartment and generates a detection sound, wherein the detection sound recording unit detects the predetermined condition change by detecting a predetermined change in sound volume when the detection sound has a volume value equal to or more than a predetermined value.
